(19) United States
(12) Patent Application Publication
(10) Pub. No.: US 2011/0245374 A1
(43) Pub. Date: Oct. 6, 2011

(54) Multiple Emulsions Containing Silicone Resin

(75) Inventors: Kathleen Barnes, Midland, MI (US); Glenn Gordon, Midland, MI (US)

(73) Assignee: DOW CORNING CORPORATION, Midland, MI (US)

(21) Appl. No.: 13/132,470

(22) PCT Filed: Dec. 3, 2009
(86) PCT No.: PCT/US2009/066540

§ 371 Date: Jun. 2, 2011

Related U.S. Application Data
(60) Provisional application No. 61/120,108, filed on Dec. 5, 2008.

(51) Int. Cl. C08J 3/07; C08L 83/04

(52) U.S. Cl. 523/337; 524/588

(57) ABSTRACT

W/O/W multiple emulsions are disclosed having improved stability against coalescence and phase separation. When a silicone MQ resin is incorporated in the oil phase, a multiple emulsion can be easily made without stringent requirements on other emulsifiers used in the system.

### CROSS REFERENCE TO RELATED APPLICATIONS

This application claims the benefit of U.S. patent application No. 61/120108 as filed 5 Dec. 2008.

### TECHNICAL FIELD

This disclosure relates to W/O/W multiple emulsions where the oil phase contains a silicone MQ resin. These multiple emulsions have improved stability against coalescence and phase separation.

### BACKGROUND

A multiple emulsion is an emulsion where a primary emulsion of liquid 1 dispersed in liquid 2 is in turn dispersed in a 3^{rd} liquid. Most of the multiple emulsions are of the O/W/O (oil-in-water-in-oil) type or W/O/W (water-in-oil-in-water) type, where O is an apolar or an “oil” phase and W is a polar or an aqueous, e.g., “water” phase. The internal dispersed phase and the external continuous phase in either O/W/O or W/O/W can be of the same or different compositions.

Multiple emulsions find particular usage in agriculture, pharmaceuticals, foods stuff, cosmetics, personal care, household care, and catalysis, mainly for the protection and delivery of active ingredients by entrapment and sustained release of the actives. For instance, in rinse-off applications involving water based formulations such as in shampoo and shower gel, a simple oil-in-water emulsion will be ineffective in delivering water soluble or water dispersible actives since the actives can only be incorporated in the external aqueous phase and thus be washed off , therefore not deliver its benefit. Using a multiple emulsion such as a W/O/W system, the water soluble or dispersible active can be incorporated in the internal aqueous phase and be protected by the oil film from being easily washed away. Similarly, in applications where the actives are to be slowly released, such as fragrance or medication, the internal phase of a multiple emulsion can be an excellent reservoir to contain the active, with the intermediate phase being a barrier for slower or controlled release.

Multiple emulsions can also be used for protecting sensitive molecules from the external phase, (antioxidation for example). Also, if two active ingredients are to be separated from each other but still contained in the same formulation, one can form a multiple emulsion with the first active ingredient incorporated in the internal dispersed phase and the second in the external continuous phase.

Typically, there are two methods used to make a multiple emulsion of the A₁/B/A₂ type. The first method is a two-step process, or sometimes referred to as the two-pot process. In the two-pot process, the primary emulsion A₁/B is made first (in the first pot) using one type of emulsifier having a higher affinity towards phase B, and the primary emulsion is then dispersed in the external continuous phase A₂ (in the second pot) containing another type of emulsifier having a higher affinity towards phase A₂. The first step usually involves homogenization or high shear to ensure good dispersion and small droplet size of phase A₁ in phase B, while in the second step, care has to be taken not to rupture droplets of the primary emulsion while dispersing it in the external phase A₂. Thus gentle mixing or low shear is often emphasized in the second step. The second method of making a multiple emulsion is the one-pot process. In the one-pot process, one starts with the intermediate phase B and subsequently add ingredients of the phase A1 and A2 under vigorous agitation or high shear to arrive at a multiple emulsion; a combination of the two types of emulsifiers is often used and the emulsifiers can be included in either the phase B or in the A's.

One drawback for using multiple emulsions in product formulations is their lack of thermodynamic stability. Multiple emulsion droplets often coalesce via one of two mechanisms leading to emulsion phase separation. The first mechanism is a coalescence of the inner droplets with the external continuous phase, in other words, the merging of the W₁/O interface with the O/W₂ interface due to the rupture of the oil phase film. This instability irreversibly transforms a multiple emulsion into a simple emulsion. The second type of instability results from coalescence between the inner droplets themselves within the intermediate phase, which results in larger inner droplets but otherwise the emulsion may still have the multiplicity; however, the coalescence of the inner droplets can quickly lead to coalescence of the inner droplets with the external continuous phase. Often, both modes of coalescence occur in an unstable multiple emulsion.

Typically, a multiple emulsion requires two sets of emulsifiers to stabilize the two types of interfaces. Even when stabilized by emulsifiers, since the droplet sizes in multiple emulsions are usually large (microns to hundreds of microns), the rate of sedimentation or creaming due to gravity and hence the rate of flocculation in a multiple emulsion is much faster than that in a fine simple emulsion. Unless special means are provided to strengthen the interfaces, coalescence usually quickly follows flocculation leading to phase separation. Multiple emulsions also lack shear stability, as shear can invert a multiple emulsion to a more stable simple emulsion and thus lose their intended purpose in applications. As such, most of the multiple emulsions that have stability long enough for practical use employ special methods to prevent inversion or coalescence. One method, for example, is to gel the intermediate aqueous phase in a O/W/O or the external aqueous phase in a W/O/W multiple emulsion by means such as using polymer gums and thickeners or in-situ polymerization. Another method is to use liquid crystal forming surfactant systems, for example, a combination of long chain alcohol with ethoxylated fatty alcohol, to strengthen the interface. One can also use solid particulate stabilizer such as fumed or functionalized silica, clays, wax crystals, etc. to prevent coalescence as in Pickering emulsions. These various means have both pros and cons; in particular, they each limit the utility of the final multiple emulsion and restrict the selection and level of the surfactant used.

Thus, there is a need to identify improved W/O/W multiple emulsions that are stable against coalescence and phase separation.

### SUMMARY

The present disclosure is directed to W₁/O/W₂ multiple emulsions that have improved stability against coalescence and phase separation. It is discovered that when a silicone MQ resin is incorporated in the oil phase, a multiple emulsion can be easily made without stringent requirements on other emulsifiers used in the system and the resulting multiple emulsion is stable against phase separation for months to years.

The present disclosure provides a process for making a w/o/w multiple emulsion comprising;
i) preparing an oil phase comprising an emulsifier and a silicone MQ resin,
ii) admixing an aqueous phase to the oil phase incrementally or at a steady rate until phase inversion occurs to form a w/o/w multiple emulsion,
iii) optionally, admixing additional water to the w/o/w multiple emulsion.

### DETAILED DESCRIPTION

The present disclosure is directed to W₁/O/W₂ multiple emulsions. The internal (W₁) and external continuous (W₂) phases in the multiple emulsion of the present invention are aqueous or non-aqueous polar phases. Examples of an aqueous phase are water, aqueous solutions or aqueous dispersions containing water soluble or dispersible compounds. Examples of non-aqueous polar phases include glycols, lower alcohols, polyalcohols such as glycerol. Typically, W₁ and W₂ are aqueous phases. The internal phase W₁ as well as the external phase W₂ can also contain soluble or dispersible active ingredients aimed for specific application benefit, such active ingredients being chosen from the family of dyes, fragrances, vitamins, drugs, fertilizers, pesticides, catalyst, etc. The internal (W₁) and external continuous (W₂) phases can have the same or different compositions.

The intermediate oil phase (O) is immiscible with both the internal (W₁) and the external (W₂) phase and can be volatile or non-volatile hydrocarbons, functional substituted hydrocarbons, silicones or mixtures thereof. The oil phase further contains a silicone MQ resin dissolvable or dispersible in the hydrocarbon or silicone medium. The nature of the hydrocarbon or silicone in the oil phase is not critical provided that it is not completely non-wettable with the silicone MQ resin.

The internal (W₁) phase constitutes 1-80, preferably 10-60 weight percent of the multiple emulsion composition. The external continuous (W₂) phase constitutes 1-80, alternatively 10-60 weight percent of the multiple emulsion composition. The intermediate (O) phase constitutes 1-80, preferably 10-60 weight percent of the multiple emulsion composition.

The first step in the process for making a w/o/w multiple emulsion according to the present disclosure involves preparing an oil phase comprising an emulsifier and a silicone MQ resin.

### Silicone MQ Resin

The silicone MQ resin consists of monovalent trifunctionalsiloxy (M) groups of the formula R₃SiO₁/₂ and tetrafunctional (Q) groups of the formula SiO_{4/2} wherein R denotes a hydrogen, a hydroxyl, a vinyl, or a monovalent hydrocarbon or functional substituted hydrocarbon radical having 1 to 6 carbon atoms. Typically, more than 80 mole percent of the R groups are methyl group. The number ratio of M groups to Q groups is in the range 0.5:1 to 1.5:1, preferably 0.6:1 to 1.2:1. The resin contains from 0 to 5 percent by weight silicon-bonded hydroxyl radicals which is presented in the form as dimethylhydroxysiloxy (HO)(CH₃)₂SiO_{1/2} units.

MQ resins suitable for use in the oil phase of the present emulsions may be obtained by methods known in the art. For example, U.S. Pat. No. 2,814,601 to Currie et al., Nov. 26, 1957, which is hereby incorporated by reference, discloses that MQ resins can be prepared by converting a water-soluble silicate into a silicic acid monomer or silicic acid oligomer using an acid. When adequate polymerization has been achieved, the resin is end-capped with trimethylchlorosilane to yield the MQ resin. Another method for preparing MQ resins is disclosed in U.S. Pat. No. 2,857,356 to Goodwin, Oct. 21, 1958, which is hereby incorporated by reference. Goodwin discloses a method for the preparation of an MQ resin by the cohydrolysis of a mixture of an alkyl silicate and a hydrolyzable trialkylsilane organopolysiloxane with water.

The MQ resins suitable as a component in the oil phase in the present disclosure may contain D and T units, providing that at least 80 mole %, alternatively 90 mole % of the total siloxane units are M and Q units. The MQ resins may also contain hydroxy groups. Typically, the MQ resins have a total weight % hydroxy content of 2-10 weight %, alternatively 2-5 weight %. The MQ resins can also be further “capped” wherein residual hydroxy groups are reacted with additional M groups.

While not intending to be limited by theory, it is believed that the incorporation of silicone MQ resin in the oil phase of a W₁/O/W₂ system serves to provide a barrier between the internal (W₁) and the external (W₂) phases as well as to prevent coalescence of the inner droplets

Another potential benefit of using silicone resin in the oil phase of the multiple emulsion is that the silicone resin may provide film forming properties in certain end uses such as coating applications. So when the multiple emulsion is applied to a substrate, after evaporation of the external continuous phase, the oil phase containing the silicone resin can dry to a film, trapping some of the internal phase containing the active ingredients.

### Emulsifiers

At least one emulsifier with a HLB or an effective HLB value of greater than 10 is required in making the multiple emulsion of the present invention. The emulsifiers may be selected from anionic, cationic, nonionic or amphoteric surfactants. Mixtures of one or more of these may also be used. Preferably, an anionic or an anionic plus a nonionic surfactant, or a combination of two nonionic surfactants, one of low HLB and one of high HLB, is used.

Examples of suitable anionic surfactants include alkali metal soaps of fatty acids, alkali metal or amine salts of alkyl aryl sulfonic acid, for example triethanolamine salt of dodecyl benzene sulfonic acid, long chain (fatty) alcohol sulfates, olefin sulfates and sulfonates, sulfated monoglycerides, sulfated esters, sulfonated ethoxylated alcohols, sulfosuccinates, alkane sulfonates, phosphate esters, alkyl isethionates, alkyl taurates and/or alkyl sarcosinates.

Examples of suitable nonionic surfactants include condensates of ethylene oxide with fatty alcohol or fatty acid, condensates of ethylene oxide with amine or amide, condensation products of ethylene and propylene oxides, esters of glycerol, sucrose or sorbitol, fatty acid alkylol amides, sucrose esters, fatty amine oxides, and siloxane polyoxyalkylene copolymers.

Representative examples of suitable commercially available nonionic surfactants include polyoxyethylene fatty alcohols sold under the tradename BRIJ by Uniqema (Croda Inc.), Edison, N.J. Some examples are BRIJ® L23, an ethoxylated alcohol known as polyoxyethylene (23) lauryl ether, and BRIJ® L4, another ethoxylated alcohol known as polyoxyethylene (4) lauryl ether. Some additional nonionic surfactants include ethoxylated alcohols sold under the trademark TERGITOL® by The Dow Chemical Company, Midland, Mich. Some example are TERGITOL® TMN-6, an ethoxylated alcohol known as ethoxylated trimethylnonanol; and various of the ethoxylated alcohols, i.e., C₁₂-C₁₄ secondary alcohol ethoxylates, sold under the trademarks TERGITOL® 15-S-5, TERGITOL® 15-S-12, TERGITOL® 15-S-15, and TERGITOL® 15-S-40.

The oil phase of the present disclosure contains at least one silicone MQ resin and at least one emulsifier, as defined above. As used herein “oil phase” means a hydrophobic phase and may contain additional organic or silicone components in combination with the silicone MQ resin and emulsifier.

The silicone MQ resin is incorporated in the oil phase of the multiple emulsion in the amount of 1-70, preferably 10-50 weight percent of the oil phase.

The total amount of emulsifiers used is 0.1-50, alternatively 1-10 weight percent of the oil phase present in the multiple emulsion.

Additional organic components that may be used in the oil phase are liquids including those considered as oils or solvents. The organic liquids are exemplified by, but not limited to, aromatic hydrocarbons, aliphatic hydrocarbons, non water soluble alcohols, aldehydes, ketones, amines, esters, ethers, glycols, glycol ethers, alkyl halides and aromatic halides. Hydrocarbons include, isododecane, isohexadecane, Isopar L (C11-C13), Isopar H (C11-C12), hydrogentated polydecene, and various mineral oils. Ethers and esters include, isodecyl neopentanoate, neopentylglycol heptanoate, glycol distearate, dicaprylyl carbonate, diethylhexyl carbonate, propylene glycol n butyl ether, ethyl-3 ethoxypropionate, propylene glycol methyl ether acetate, tridecyl neopentanoate, propylene glycol methylether acetate (PGMEA), propylene glycol methylether (PGME). octyldodecyl neopentanoate, diisobutyl adipate, diisopropyl adipate, propylene glycol dicaprylate/dicaprate, and octyl palmitate. Additional organic liquids include fats, oils, fatty acids, and fatty alcohols.

The oil phase may encompass a vegetable oil. Representative, non-limiting examples of vegetable oils include; jojoba oil, soybean oil, safflower oil, linseed oil, corn oil, sunflower oil, canola oil, sesame oil, cottonseed oil, palm oil, rapeseed oil, tung oil, fish oil, peanut oil, sweet almond oil, beautyleaf oil, palm oil, grapeseed oil, arara oil, cottonseed oil, apricot oil, castor oil, alfalfa oil, marrow oil, cashew nut oil, oats oil, lupine oil, kenaf oil, calendula oil, euphorbia oil, pumpkin seed oil, coriander oil, mustard seed oil, blackcurrant oil, camelina oil, tung oil tree oil, peanuts oil, opium poppy oil, castor beans oil, pecan nuts oil, brazil nuts oil, oils from brazilian trees, wheat germ oil, candlenut oil, marrow oil, karate butter oil, barley oil, millet oil, blackcurrant seed oil, shea oil (also known as shea butter), maize oil, evening primrose oil, passionflower oil, passionfruit oil, quinoa oil, musk rose oil, macadamia oil, muscat rose oil, hazelnut oil, avocado oil, olive oil or cereal (corn, wheat, barley or rye) germ oil and combinations thereof.

The additional silicone components used in the oil phase may be a low viscosity organopolysiloxane or a volatile methyl siloxane or a volatile ethyl siloxane or a volatile methyl ethyl siloxane having a viscosity at 25° C. in the range of 1 to 1,000 mm²/sec such as hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, hexadeamethylheptasiloxane, heptamethyl-3-{(trimethylsilyl)oxy)}trisiloxane, hexamethyl-3,3,bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes.

The additional silicone components used in the oil phase may be a polydimethylsiloxane having a viscosity greater than 1000 mm²/s at 25° C. The “endblocking” group of the polydimethylsiloxane is not critical, and typically is either OH (i.e. SiOH terminated), alkoxy (RO), or trimethylsiloxy (Me₃SiO).

The organopolysiloxane may also be a mixture of various polydimethylsiloxanes of varying viscosities or molecular weights. Furthermore, the organopolysiloxane may also be a mixture of a high molecular weight organopolysiloxane, such as a gum or elastomer in a low molecular weight or volatile organopolysiloxane. The polydimethylsiloxane gums suitable for the present invention are essentially composed of dimethylsiloxane units with the other units being represented by monomethylsiloxane, trimethylsiloxane, methylvinylsiloxane, methylethylsiloxane, diethylsiloxane, methylphenylsiloxane, diphenylsiloxane, ethylphenylsiloxane, vinylethylsiloxane, phenylvinylsiloxane, 3,3,3-trifluoropropylmethylsiloxane, dimethylphenylsiloxane, methylphenylvinylsiloxane, dimethylethylsiloxane, 3,3,3-trifluoropropyldimethylsiloxane, mono-3,3,3-trifluoropropylsiloxane, aminoalkylsiloxane, monophenylsiloxane, monovinylsiloxane and the like.

Representative, non-limiting examples of commercially available polydimethylsiloxanes useful as additional oil phase components include, DOW CORNING® 200 fluids of varying viscosities (Dow Corning Corporation, Midland, Mich.).

The silicone MQ resin is incorporated into the oil phase, either as a solution or a dispersion, is mixed with all or part of the emulsifiers. Mixing in step (i) can be accomplished by any method known in the art to affect mixing of high viscosity materials. The mixing may occur either as a batch, semi-continuous, or continuous process. Mixing may occur, for example using, batch mixing equipments with medium/low shear include change-can mixers, double-planetary mixers, conical-screw mixers, ribbon blenders, double-arm or sigma-blade mixers; batch equipments with high-shear and high-speed dispersers include those made by Charles Ross & Sons (NY), Hockmeyer Equipment Corp. (NJ); batch equipments with high shear actions include Banbury-type (CW Brabender Instruments Inc., NJ) and Henschel type (Henschel mixers America, TX). Illustrative examples of continuous mixers/compounders include extruders single-screw, twin-screw, and multi-screw extruders, co-rotating extruders, such as those manufactured by Krupp Werner & Pfleiderer Corp (Ramsey, NJ), and Leistritz (NJ); twin-screw counter-rotating extruders, two-stage extruders, twin-rotor continuous mixers, dynamic or static mixers or combinations of these equipments.

Step ii) in the present process involves admixing an aqueous phase to the oil phase incrementally or at a steady rate until phase inversion occurs to form a w/o/w multiple emulsion. The average rate of addition of the aqueous phase should be no more than 10% based on the weight of the oil phase per minute, alternatively no more than 1% per oil phase per minute. Slow addition enables the aqueous phase to be well dispersed into the oil phase to form a fine inner W₁/O droplets.

The aqueous phase, or aqueous phase containing the rest of the emulsifiers, is added stepwise or continuously but with a slow rate to the oil phase containing the silicone resin with mixing. Mixing is affected with vigorous agitation or high shear and is allowed to continue until phase inversion occurs. As used herein phase inversion means that the external continuous phase makes a sudden change from oil to aqueous.

The amount of aqueous phase added in step ii) to cause phase inversion can vary depending on the type of the oil phase and process condition, generally the amount of water or aqueous phase is from 5 to 200 parts per 100 parts by weight of the step I oil phase mixture, alternatively from 10 to 100 parts per 100 parts by weight of the oil phase,

When water is added to the mixture from step I in incremental portions, each incremental portion should be added successively to the mixture after the previous portion of water has been well dispersed into the mixture, such that the overall rate is not more than 10 parts of water per 100 parts of oil per minute while keeping a concurrent mixing.

Mixing in step (ii) can be accomplished by any method known in the art to affect mixing of emulsions. The mixing may occur either as a batch, semi-continuous, or continuous process. Any of the mixing methods as described for step (i), may be used to affect mixing in step (ii). However, typically the emulsion is formed by subjecting the mixture of step ii) to additional shear mixing. The shear mixing may be provided in devices such as a rotor stator mixer, a homogenizer, a sonolator, a microfluidizer, a colloid mill, mixing vessels equipped with high speed spinning or with blades imparting high shear.

The resulting emulsion from step ii) can be further diluted with water. Other additives such as biocide, thickener and fillers can be optionally added. Non-aqueous multiple emulsions can also be made using the same process described here.

### Use

The multiple emulsion of the present disclosure can be used as it is or incorporated in application formulations in the areas of agriculture, pharmaceuticals, foods stuff, cosmetics, personal care, household care, and catalysis. It is particularly useful for the protection and delivery of active ingredients when the active ingredients are incorporated in the multiple emulsion of the present invention.

### EXAMPLES

These examples are intended to illustrate the invention to one of ordinary skill in the art and should not be interpreted as limiting the scope of the invention set forth in the claims. All measurements and experiments were conducted at 23° C., unless indicated otherwise.

### Example 1

In a 100 ml stainless steel beaker was mixed 29.76 g of a polydimethylsiloxane of viscosity 400 cp and 24 g of a trimethylsiloxy capped siloxane MQ resin of the number averaged molecular weight 4,700 containing less than 1 wt % of silicon bonded hydroxyl group, and having a M:Q molar ratio of 48:52. The mixture was mixed using a Lightnin mixer till a clear solution was formed. To the mixture was then added 4.3 g of BioSoft® N-300 and mixed till a homogeneous dispersion was formed. 1.5 g, then 1.6 g and then 3.01 g of water were sequentially added while the mixture was sheared at 900 RPM using a cowles blade. A thick gel-like dispersion was formed. Another 25.43 g of water was then added to the mixture under continued agitation, forming a thick emulsion. Particle size measurement by a Microtrac™ particle sizer showed majority of the particles centered around 2.5 microns. Optical microscopy and cryo-transmission electron microscopy revealed that the emulsion was a W/O/W multiple emulsion. The emulsion was shelf aged under ambient condition for 3 years and showed neither sign of cream or sedimentation nor phase separation when examined by the naked eyes; and when examined by an optical microscope, the same type of image was obtained as that when freshly prepared three years earlier.

A similar sample was also prepared using a Speed Mixer ™ DAC 150 FVZ with a spin speed set at 3000 RPM. Each addition of material was followed by spin for 30 seconds. This resulted in a W/O/W emulsion of similar feature.

### Example 2

In a 100 ml stainless steel beaker was mixed 18.75 g of a polydimethylsiloxane of viscosity 9,000 cp and 18.75 g of the siloxane MQ resin in Example 1. The mixture was mixed using a Lightnin mixer till a clear solution was formed. To the mixture was then added 1.96 g of Brij®30 and 1.68 g of Brij®35L and mixed till a homogeneous dispersion was formed. Water was then added gradually while the mixture was sheared at 1400 RPM using a cowles blade. A total of 18.37 g of water was added when the emulsion was phase inverted to an aqueous emulsion, i.e., the external phase became water. The emulsion was then diluted with an additional 16.13 g of water. The final emulsion was a W/O/W multiple emulsion as confirmed by optical microscope.

### Example 3

In a 100 ml stainless steel beaker was mixed 27.24 g of a polydimethylsiloxane of viscosity 9,000 cp and 13.25 g of the siloxane MQ resin in Example 1. The mixture was mixed in a Lightnin mixer till a clear solution was formed. To the mixture was then added 2.25 g of Pluronic® P103 and 0.99 g of Pluronic® F108 and mixed till a homogeneous dispersion was formed. Water was then added stepwise, 1-2 g at a time, while the mixture was sheared at 1400 RPM using a cowles blade. A total of 4.0 g of water was added when the emulsion was phase inverted to an aqueous emulsion, i.e., the external phase became water. The emulsion was then diluted with an additional 52.12 g of water. The final emulsion was a W/O/W multiple emulsion; optical micrographs confirmed the formation of the multiple emulsion.

### Example 4

In this example, a Speed Mixer™ DAC 150 FVZ was used with a 30 ml plastic cup; spin cycle was set at 3000 RPM and for 22 seconds. A content of 9 g of a (+)-Limonene solution containing 10 wt % of the siloxane MQ resin in Example 1, 0.51 g BioSoft® N-300 and 0.22 g Brij® 30 was spatula mixed and then spun for one spin circle. The mixture formed a poor dispersion due to immiscibility of the surfactants in the oil phase. 1.78 g water was added to the content, spatula mixed and spun for one cycle. A homogeneous emulsion was formed which is readily dispersible in water. Examination using an optical microscope revealed that it was a W/O/W multiple emulsion.

### Example 5

In a 200 ml stainless steel beaker was added 53.76 g of a mixture of a polydimethylsiloxane of viscosity 2000 cp and a siloxane MQ resin of the number averaged molecular weight 4,300 containing less than 3.1 wt % of silicon bonded hydroxyl group and having a M:Q molar ratio of 43:57, the ratio of PDMS to resin being 6:4. To the mixture was added 4.3 g of BioSoft® N-300 and mixed using a Lightnin mixer till a homogeneous dispersion was formed. Water was added incrementally, 1-10 g at a time, while the mixture was sheared at 900 RPM using a cowles blade. A total of 62 g was added when a W/O/W multiple emulsion was formed. Another 15 g of water was added to dilute the emulsion. An optical micrograph confirmed the formation of a W/O/W emulsion.

### Comparative Example

The Speed Mixer™ in Example 4 was used with the same settings. The oil phase in this comparative example is a polydimethylsiloxane of viscosity 55,000 cp which is comparable to the viscosity of the blend of PDMS with MQ resin in Example 1. 18 g of this PDMS was mixed with 1.44 g BioSoft® N-300, the content was spun forming a homogeneous dispersion. 0.5 g water was added, mixed in and the content spun forming a translucent soft gel. 2.5 g and then 9 g water was subsequently added, each time followed by spin. A thin, homogeneous emulsion was arrived and particle size measurement by a Microtrac™ particle sizer showed a monomodal distribution centered around 1.7 microns. Examination using an optical microscope revealed a simple O/W emulsion with no internal structure in the emulsion droplets.

1. A process for making a w/o/w multiple emulsion comprising;
i) preparing an oil phase comprising an emulsifier and a silicone MQ resin,
ii) admixing an aqueous phase to the oil phase incrementally or at a steady rate until phase inversion occurs to form a w/o/w multiple emulsion,
iii) optionally, admixing additional water to the w/o/w multiple emulsion.

2. The process of claim 1 wherein the silicone MO resin has an average formula such that the number ratio of M groups to Q groups is in the range 0.5:1 to 1.5:1.

3. The process of claim 1 wherein the oil phase contains 1 to 70 weight percent of the silicone MQ resin and 0.1 to 50 weight percent of the emulsifier with the proviso that all components of the oil phase sums to 100 weight percent.

4. The process of claim 1 wherein the oil phase further comprises a polydimethylsiloxane fluid.

5. The process of claim 1 wherein the amount of aqueous phase added in each incremental portion in step ii) is 5 to 200 parts per 100 parts by weight of the oil phase.

6. The multiple phase emulsion prepared by the process of claim 1.
